(19) United States
(12) Patent Application Publication
(10) Pub. No.: US 2009/0039699 A1
(43) Pub. Date: Feb. 12, 2009

(54) Complex wheel rim assembly structure

(75) Inventor: Ming-Te Liao, Shulin City (TW)

Correspondence Address: TROXELL LAW OFFICE PLLC, SUITE 1404, 5205 LEESBURG PIKE, FALLS CHURCH, VA, 22041, US

(73) Assignee: Rimtech Industrial Co., Ltd.

(21) Appl. No.: 11/898,199

(22) Filed: Sep. 10, 2007

(30) Foreign Application Priority Data
Aug. 7, 2007 (TW) 096212987

(51) Int. Cl. B60B 25/00

(52) U.S. Cl. 301/95.11

(57) ABSTRACT

A complex wheel rim assembly structure contains a hub, a front member, a rear member, a leak-proof O-ring, and plural assembly members. The hub includes plural radial plates and assembly holes. An inward folding edge is close to a central hole of the front member and has plural assembly holes, and an outward expanding edge is at an exterior side of the front member. An inward folding edge is close to a central hole of the rear member and has plural assembly holes, and an outward expanding edge is at an exterior side of the rear member. Grooves are at exterior sides of the inward folding edges of the front and rear members, the leak-proof O-ring is between the two inward folding edges of the front and rear members, and the wheel rim is assembled through the plural assembly members.

### BACKGROUND OF THE INVENTION

(a) Field of the Invention

The present invention relates to a complex wheel rim assembly structure, and more particularly to a complex wheel rim structure which is convenient to use, and is suitable for tires or similar structures of a large vehicle, such as a truck, a trailer, or a cargo container.

(b) Description of the Prior Art

An automobile can effectively reduce distance between people, and sufficiently satisfy a traveling need of a user. Through many years of research and development, an automobile wheel rim has been converted from a covered steel rim to an aluminum alloy wheel rim. In a mean time, the aluminum alloy wheel rim has been also converted from an integrally connected wheel rim to an assembly-type wheel rim. Referring to FIG. 6 and FIG. 6A, a conventional wheel rim is assembled by a front member 21 and a rear member 22, with an end of the front member 21 being provided with an inward folding edge 23, and an end of the rear member 22 being also provided with an inward folding edge 24. In assembling the wheel rim, the inward folding edge 23 of the front member 21 is superimposed with the inward folding edge 24 of the rear member 22 to assemble both the front member 21 and the rear member 22. Next, a corner slit at a superimposed part between the front member 21 and the rear member 22 is filled with silicon glue 25, such that when the assembly-type wheel rim is sheathed into a rubber peel to form a tire, air will not leak out from the superimposed slit between the inward folding edges 23, 24 after the tire is inflated.

Although the aforementioned structure can prevent air from leaking out, if the front member 21 or the rear member 22 needs to be replaced for that assembly-type wheel rim, then the silicon glue 25 should be scraped out completely, such that the front member 21 or the rear member 22 after replacement can be locked and assembled once again. If the silicon glue 25 is not removed completely, then the tire which is made by the assembly-type wheel rim that is assembled the second time, will have a much higher possibility of leaking. On the other hand, after pasting with the silicon glue 25, the wheel rim should be put still until the silicon glue 25 is dry, before fixing into the tire for inflation, and it will probably require 24 hours to wait until the silicon glue 25 is dry. Therefore, for a user who refits the front member or the rear member of the wheel rim, the tire cannot be replaced immediately for driving, which is rather imperfect.

### SUMMARY OF THE INVENTION

The primary object of the present invention is to provide a complex wheel rim assembly structure, which is convenient to assemble and use, such that a leak-proof effect can be achieved in usage.

Another object of the present invention is to provide a complex wheel rim assembly structure, which facilitates adjustment of wheel width, and allows the wheel rim to be immediately fixed on a tire for driving, after replacing a front member or a rear member of the wheel rim independently.

Accordingly, the present invention includes a hub, a front member, a rear member, a leak-proof O-ring, and a plurality of assembly members. The hub is provided with a plurality of radial plates and a plurality of assembly holes, the front member is provided with an inward folding edge which is located at a location close to a central hole and is opened with a plurality of assembly holes, and an outward expanding edge at an exterior side, and the rear member is also provided with an inward folding edge which is located at a location close to a central hole and is opened with a plurality of assembly holes, and an outward expanding edge at an exterior side. The front and rear members are provided with grooves at exterior sides of the inward folding edges, the leak-proof O-ring is located between the two inward folding edges of the front and rear members; whereas the hub is located on the front member, and is assembled with the front member through the plural assembly members.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows an exploded view of elements of an embodiment of the present invention.

FIG. 1A shows a local exploded view of FIG. 1.

FIG. 1B shows another local exploded view of FIG. 1.

FIG. 2 shows a perspective view of an embodiment of the present invention after being assembled, wherein a local cutaway state is shown.

FIG. 2A shows a local exploded view of FIG. 2, at part A.

FIG. 3 shows a local cutaway view of an embodiment of the present invention.

FIG. 3A shows a local exploded view of FIG. 3, at part A.

FIG. 4 shows a schematic view of a second application of an embodiment of the present invention.

FIG. 5 shows a schematic view of a third application of an embodiment of the present invention.

FIG. 6 shows a cutaway view of a conventional assembly-type wheel rim, after being assembled.

FIG. 6A shows a local exploded view of FIG. 6, at part A.

### DETAILED DESCRIPTION OF THE PREFERRED EMBODIMENTS

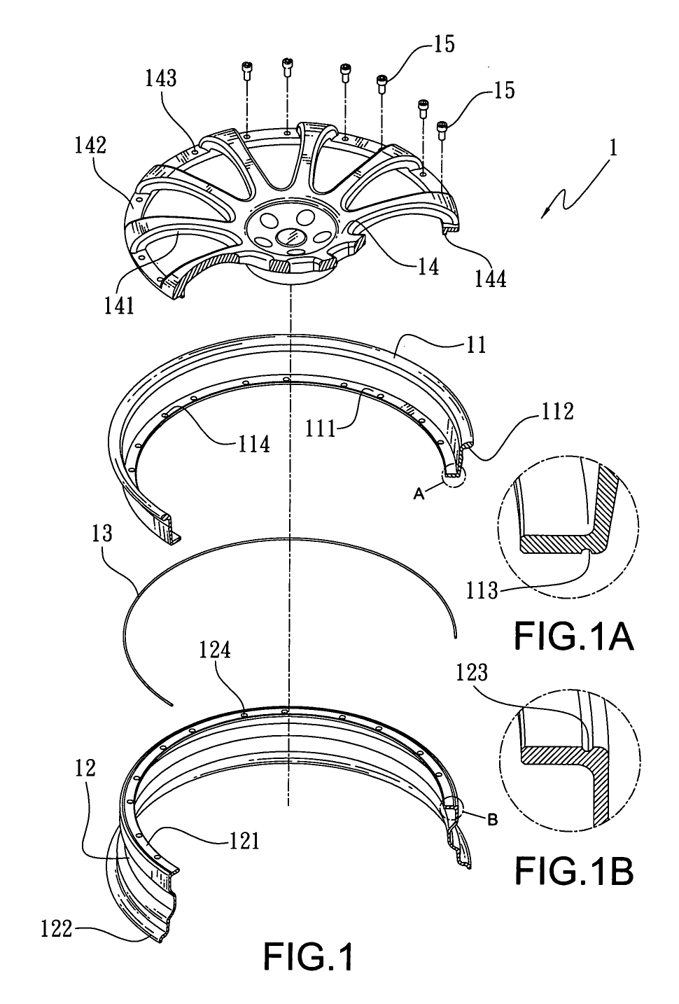

Referring to FIG. 1, FIG. 1A, and FIG. 1B, a wheel rim 1 of the present invention includes a front member 11, a rear member 12, a leak-proof O-ring 13, a hub 14, and a plurality of assembly members 15, wherein the front member 11 is a ring, with an inward folding edge 111, which is folded inward horizontally, being located at a location close to a central hole of the front member 11, and provided with a plurality of assembly holes 114, as well as with an outward expanding edge 112, which is folded outward, being located at an exterior side of the ring. In addition, a groove 113 is located at a back side of the inward folding edge 111, close to an outer rim.

The rear member 12 is also a ring, with an inward folding edge 121, which is folded inward horizontally, being located at a location close to a central hole of the rear member 12, and provided with a plurality of assembly holes 124, as well as with an outward expanding edge 122, which is folded outward, being located at an exterior side of the ring. In addition, a groove 123 is located at a top side of the inward folding edge 121, close to an outer rim.

The leak-proof O-ring 13 is located in two grooves 113, 123 of the front member 11 and the rear member 12.

A circumference of the hub 14 is provided with a plurality of radial plates 141, with two sides of each one of the radial plates 141 being connected by a connection section 142 which is provided with a plurality of assembly holes for transfixing with a plurality of assembly members 15. In addition, an inner edge of the connection section 142 is vertically protruded with a stopping edge 144.

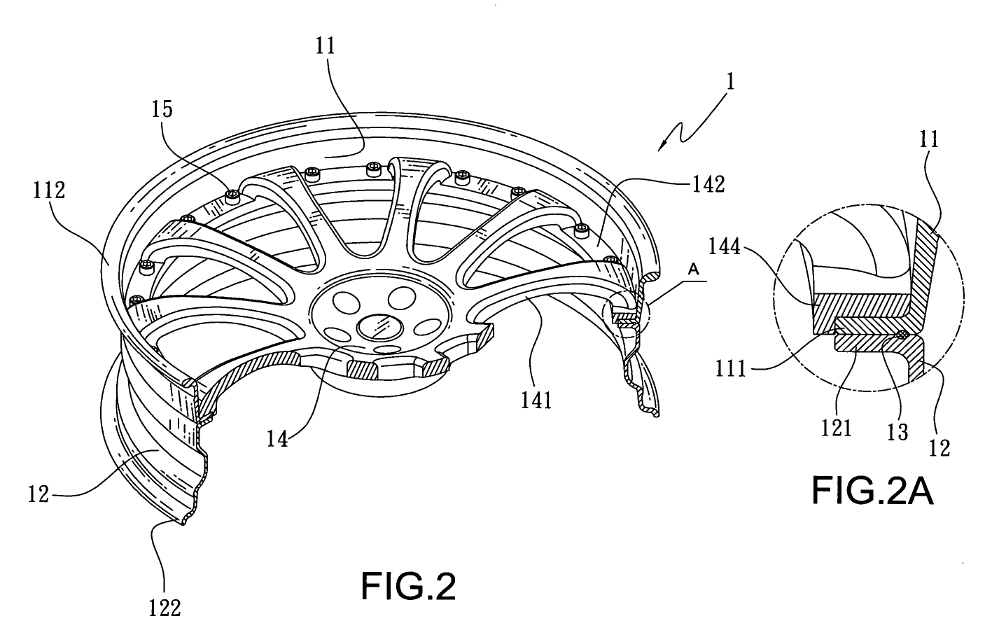

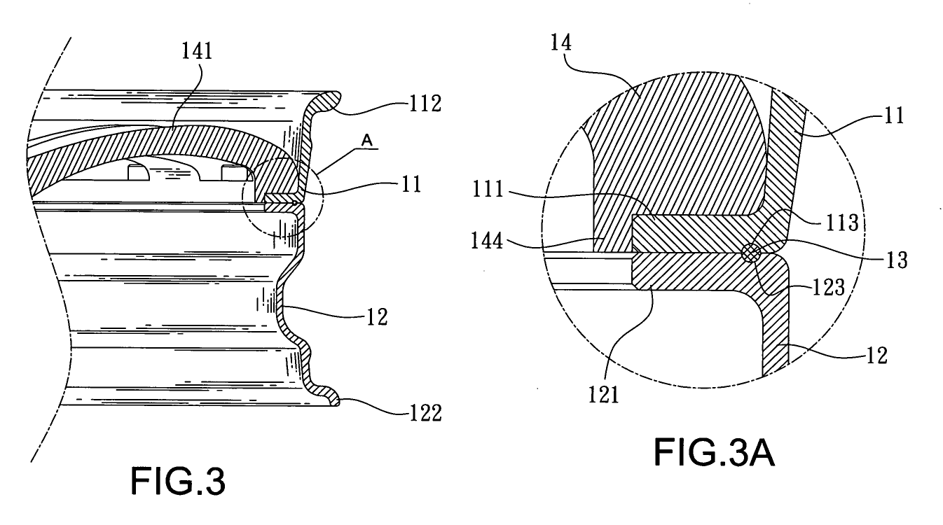

Referring to FIG. 2, FIG. 2A, FIG. 3, and FIG. 3A, when assembling, the leak-proof O-ring 13 is put into the groove 123 of the inward folding edge 121 of the rear member 12 (as shown in FIG. 1B), and the front member 11 is superimposed on the inward folding edge 121 of the rear member 12 with the inward folding edge 111 facing downward, allowing the groove 113 to enclose the entire leak-proof O-ring 13. In a mean time, the two superimposed inward folding edges 111, 121 are adjusted, enabling their assembly holes to be mutually aligned and overlapped. On the other hand, the hub 14 is superimposed from top to bottom on the inward folding edge 111 of the front member 11, enabling the stopping edge 144, which is vertically protruded from the inner rim of the connection section 142 of the hub 14, to be abutted on a side end of the inward folding edge 111 of the front member 11. Positions of the assembly holes on the connection section 142 are also adjusted, allowing each assembly hole on the hub 14, the front member 11, and the rear member 12 to be completely overlapped, followed by transfixing and assembling with the plural assembly members 15, thereby accomplishing the assembly of the wheel rim 1 of the present invention.

For the aforementioned wheel rim 1 after being assembled, as the leak-proof O-ring 13 is clipped between the inward folding edges 111, 121 of the front member 11 and the rear member 12, complete sealing without any gap is available between the two assembled members. Therefore, when the wheel rim 1 is sheathed into a tire which is then inflated, a fundamental function that tire air will not leak out is achieved. If the front member 11 or the rear member 12 needs to be replaced for that tire, the wheel rim 1 is taken out first, and then the plural assembly members 15 are dismantled completely; after that, the hub 14 is taken out, and at this time, the front member 11 or the rear member 12 can be replaced with a new one. When the new front member 11 is superimposed with the rear member 12, the grooves 113, 123 are still used to clip and enclose the leak-proof O-ring 13. Finally, through the plural assembly members 15, the hub 14, the front member 11, the leak-proof O-ring 13, and the rear member 12 are assembled into a complete wheel rim 1.

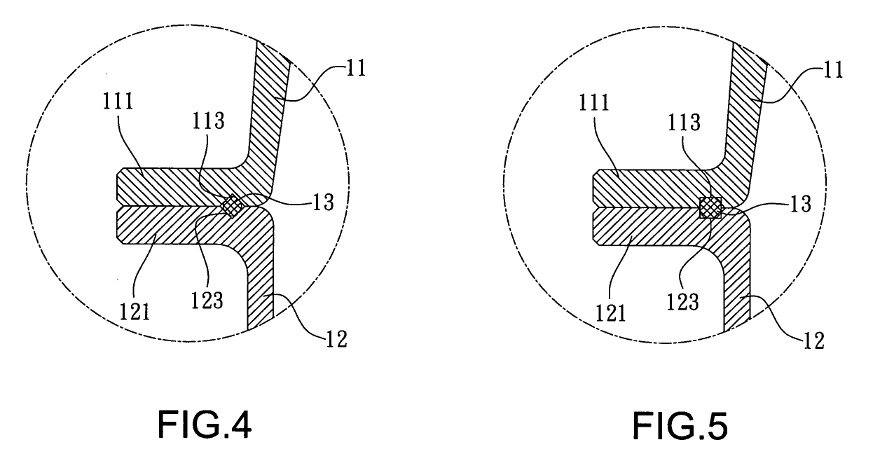

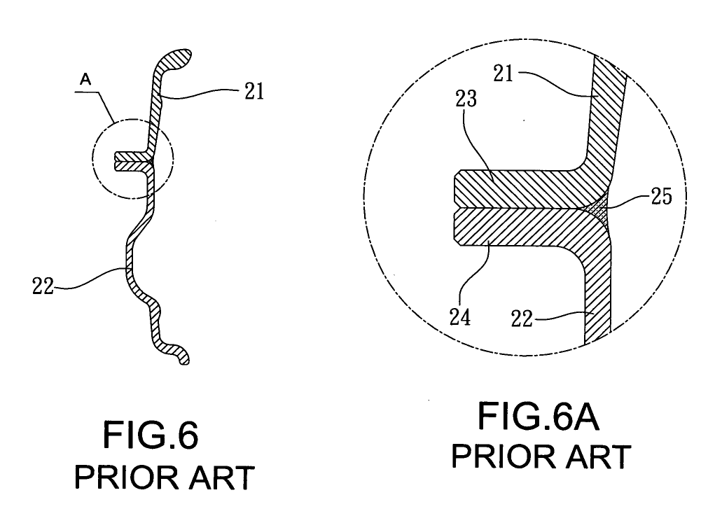

On the other hand, the grooves 113, 123 on the inward folding edges 111, 121 of the front member 11 and the rear member 12 are not limited with respect to their shape, and they can be an arc (as shown in FIG. 1A and FIG. 1B), a triangle as shown in FIG. 4, or a rectangle as shown in FIG. 5, such that when the inward folding edges 111, 121 of the front member 11 and the rear member 12 are superimposed, the two grooves 113, 123 can form respectively a rhombus groove or a square groove for emplacing the leak-proof O-ring 13. In a mean time, an aperture of the rhombus groove or the square groove is not larger than the aperture of the leak-proof O-ring 13.

Accordingly, the structures of the present invention are provided with following advantages:
1. By using the simple structures, the wheel rim with the width being conveniently and easily adjusted is assembled.
2. By installing the grooves in the inward folding edges of the front member and the rear member, the leak-proof O-ring is clipped between the two grooves, which prevents the tire air from leaking out, and can effectively improve the shortcomings that in a prior art, the silicon glue is not easily cleaned, or requires long time until it is dry.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A complex wheel rim assembly structure comprising a hub, a front member, a rear member, a leak-proof O-ring, and a plurality of assembly members, wherein a circumference of the hub is provided with a plurality of radial plates, with two sides of each of one of the radial plates being connected with a connection section having a plurality of assembly holes; the front member being a ring, with a location close to a central hole of the ring being provided with an inward folding edge, on which is opened with a plurality of assembly holes, and a bottom side of which is installed with a groove, as well as with an exterior side of the front member being provided with an outward expanding edge; the rear member being a ring, with a location close to a central hole of the ring being provided with an inward folding edge, on which is opened with a plurality of assembly holes, and a top side of which is installed with a groove, as well as with an exterior side of the front member being provided with an outward expanding edge; the leak-proof O-ring being emplaced between the front member and the rear member; and the plural assembly members locking the hub, the front member, and the rear member; accordingly, through superimposing the two inward folding edges of the front and rear members, the leak-proof O-ring being clipped in the grooves of the two inward folding edges; and through the plural assembly members, the hub, the front member, and the rear member being assembled into one body.

2. The complex wheel rim assembly structure according to claim 1, wherein an inner side of the connection section of the hub is provided downward with a stopping edge.

3. The complex wheel rim assembly structure according to claim 1, wherein the grooves of the two inward folding edges of the front member and the rear member are in an arc shape, with a concaved hole formed by combining the two grooves tightly clipping the leak-proof O-ring.

4. The complex wheel rim assembly structure according to claim 1, wherein the grooves of the two inward folding edges of the front member and the rear member are in a triangular shape, with a concaved hole formed by combining the two grooves tightly clipping the leak-proof O-ring.

5. The complex wheel rim assembly structure according to claim 1, wherein the grooves of the two inward folding edges of the front member and the rear member are in a rectangular shape, with a concaved hole formed by combining the two grooves tightly clipping the leak-proof O-ring.
